(19) United States
(12) Patent Application Publication
(10) Pub. No.: US 2007/0215364 A1
(43) Pub. Date: Sep. 20, 2007

(54) Fire-extinguishing method of a pool fire

(75) Inventors: Eiichi Murai, Osaka (JP); Akihiko Ito, Hirosaki (JP)

Correspondence Address: KOLISCH HARTWELL, P.C., 200 PACIFIC BUILDING, 520 SW YAMHILL STREET, PORTLAND, OR, 97204, US

(73) Assignee: Hatsuta Seisakusho Co., Ltd.

(21) Appl. No.: 11/649,956

(22) Filed: Jan. 5, 2007

(30) Foreign Application Priority Data
Mar. 17, 2006 (JP) 2006-74331
May 18, 2006 (JP) 2006-138484
Jul. 7, 2006 (JP) 2006-187970

(51) Int. Cl. A62C 3/06

(52) U.S. Cl. 169/68; 169/66; 169/46; 169/70

(57) ABSTRACT

Described herein is a fire-extinguishing method of a pool fire utilizing water mists, wherein the water mists are discharged so as to surround the flame base portion of a pool fire virtually without a gap, directed not to the burning surface and the flame base portion directly, but to any of positions of the flame center axis from a plurality of positions on the side of the burning surface, while water mists are being discharged toward the flame center axis above the flame base portion from a plurality of positions above the burning surface, so that the fire is extinguished.

### TECHNICAL FIELD OF THE INVENTION

The present invention relates to a fire-extinguishing method of a pool fire caused by oil or the like, and more specifically, relates to a method for effectively extinguishing a pool fire by discharging water mists toward the flame center axis (line connecting the center of the flame base portion to the apex of the flame) from a side portion of a burning surface so as to surround the flame base portion virtually without a gap, and/or by discharging a water mist downward to the flame center axis from above the burning surface.

### BACKGROUND ART

Conventionally, with respect to the fire extinguishing method of a pool fire, a facility utilizing a local fire-extinguishing process with the use of carbon dioxide, a foam fire-extinguishing process or a water atomizing process has been used. In such a facility, a pipe system for fire-extinguishing water is placed above an oil vessel (a quenching vessel or the like) having a possibility of a fire, with nozzles, directed downward, being attached thereto with predetermined intervals, so that a fire is extinguished by discharging carbon dioxide, foam, or atomized water from the nozzles downward to a fire source.

However, these methods cause the following problems: carbon dioxide tends to cause a danger of suffocation, and the foam extinguishing process tends to cause contamination to the environment, and since the water atomizing process simply discharges atomized water downward from above the flame, the atomized water is raised up by flames, failing to reach the flame base portion; consequently, this not only makes the fire-extinguishing difficult, but also flings up ambient air, resulting in a necessity of using a large amount of water.

In order to solve these problems, a method has been proposed in which by allowing a water mist to be carried on an air flow that occurs in the flame base portion of a pool fire to reach the inside of the flame, the fire is extinguished (see Japanese Patent Publication Laid-Open No. 2005-323794).

In this method, since the water mist is allowed to reach the inside of the flame, a cooling effect and an oxygen concentration reducing effect can be obtained by water vapor generated upon contact of the water mist with the flame; however, since oxygen flows into the flame base portion along the air flow, there is still room for improvements in this method.

### DISCLOSURE OF THE INVENTION

The present invention has been devised to solve the above-mentioned problems with the conventional art, and its objective is to provide a method by which a fire-extinguishing process with the use of a water mist is effectively executed in a pool fire.

The inventors of the present invention have studied hard to achieve the above-mentioned objective, and found that by utilizing a descending flow formed by water mists discharged from the upward peripheral portions toward the flame center axis, in addition to a cooling effect by the water mists, a restricting effect against flowing-in air caused by a generation of vapor and a pressure increase inside the flame is effectively exerted so that a pool fire can be extinguished in a short time, and that by surrounding the flame base portion with a wall of water mists, in addition to an effect by the phase change in the water mists, a suffocating effect, obtained by changing a course of an air flow, is also exerted so that a pool fire can be extinguished in a short time.

After examinations on these methods, the inventors of the present invention have found that, in a case where only the descending flow of water mists is utilized, although a fire-extinguishing process is easily carried out because the water mists are directed around the flame base portion even in the presence of a freeboard, a problem may arise in which flames expand laterally due to an increased pressure inside the flames occurring upon arrival of the descending flow at the burning surface, and that in a case where only the sideway flows of water mists are utilized, another problem arises in which, although, upon extinguishing, no lateral expands of flames occur, the water mists are hardly directed around the flame base portion when the freeboard is placed, resulting in that the fire is not completely extinguished with flames remaining in the edge portions.

Based upon the above-mentioned findings, the inventors of the present invention have made extensive research efforts, and found that when the problems with the descending flow and sideway flows of water mists occur, by utilizing the two types of flows in combination, the mutual disadvantages can be overcome by the mutual advantages, thereby completing the present invention.

In other words, a first aspect of the present invention, which relates to a fire-extinguishing method of a pool fire utilizing water mists, has an arrangement in which: the water mists are discharged toward the flame center axis above a flame base portion from a plurality of positions above the burning surface so as to generate a descending flow of water mists, and the descending flow forms vapor inside the flames so that the vapor increases the inner pressure of the flames to suppress a flow of oxygen toward the flame base portion, thereby extinguishing the fire.

In a preferable mode of the method of the first aspect of the present invention, nozzles capable of discharging water mists are placed at plurality of positions with equal intervals on the periphery of a circle around the flame center axis on the horizontal plane above the burning surface, and the water mists are discharged with the nozzles being directed not to the burning surface and the flame base portion directly, but to any of positions of the same flame center axis below the horizontal surface, so that the area of a circle with the nozzles being placed on the periphery thereof is made smaller than the burning area, with the water mists to be discharged being set to an average particle size in a range from 50 μm to 500 μm.

Moreover, a second aspect of the present invention, which relates to a fire-extinguishing method of a pool fire utilizing water mists, has an arrangement in which: the water mists are discharged so as to surround the flame base portion of a pool fire virtually without a gap, with the nozzles being directed not to the burning surface and the flame base portion directly, but to any of positions of the flame center axis, so that an oxygen supply to the flame base portion is prevented by vapor generated from the water mists, thereby extinguishing the fire.

In a preferable mode of the method of the second aspect of the present invention, the discharging directions of the water mists are made virtually in parallel with flows of flames, with a flow rate of the water mists to be discharged being set to a speed that sufficiently prevents an air flow from entering the flame base portion, with the water mists to be discharged being set to an average particle size in a range from 10 μm to 200 μm.

Moreover, a third aspect of the present invention, which relates to a fire-extinguishing method of a pool fire utilizing water mists, has an arrangement in which: the water mists are discharged so as to surround the flame base portion of a pool fire virtually without a gap, directed not to the burning surface and the flame base portion directly, but to any of positions of the flame center axis from a plurality of positions on the side of the burning surface, while water mists are being discharged toward the flame center axis above the flame base portion from a plurality of positions above the burning surface, so that the fire is extinguished.

In a preferable mode of the third aspect of the present invention, the discharging process of water mists from the sides of the burning surface is carried out prior to the discharging process of water mists from above the burning surface. Moreover, in the preferable mode of the third aspect of the present invention, nozzles capable of discharging water mists are attached to a plurality of places with equal intervals so as to surround the burning surface on the periphery of the burning surface, and water mists are discharged with the nozzles being directed not to the burning surface and the flame base portion directly, but to any of positions of the flame center axis above the burning surface. Moreover, in the preferable mode of the third aspect of the present invention, nozzles capable of discharging water mists are placed at a plurality of portions with equal intervals on a circle around the flame center axis on the horizontal plane above the burning surface, and the water mists are discharged with the nozzles being directed not to the burning surface and the flame base portion directly, but to any of positions of the flame center axis below the horizontal surface.

In the method of the first aspect of the present invention, by discharging water mists from a plurality of positions above the burning surface toward the flame center axis, a descending flow of the water mists is generated so that the fire is extinguished; therefore, in addition to a cooling effect and an oxygen concentration diluting effect derived from the water mists, a restricting effect against flowing-in oxygen caused by a pressure increase inside the flame is effectively exerted with a result that a quick fire-extinguishing process with the use of a small amount of water is achieved. Moreover, in the method of the second aspect of the present invention, since the amount of oxygen supply to the flame base portion is reduced by surrounding the flame base portion with the water mists without a gap, it is possible to exert a suffocation effect by preventing the oxygen supply, in addition to a cooling effect and an oxygen concentration diluting effect derived from a phase change from a liquid to a gas of the water mists, and consequently to extinguish a fire quickly with the use of a small amount of water. Moreover, in the method of the third aspect of the present invention, by discharging water mists from the sides of the burning surface toward the flame center axis so as to surround the flame base portion, as well as by discharging water mists from above the burning surface downward to the flame center axis, it is possible to effectively prevent the oxygen supply to the flame base portion, and also to restrict the flowing-in oxygen due to an increased pressure inside the flames, in addition to the cooling effect and oxygen concentration diluting effect derived from a phase change from a liquid to a gas of the water mists, and consequently to extinguish a fire quickly with the use of a small amount of water. Moreover, problems that would be caused individually by the discharging operation of the water mists from the sides of the burning surface and by the discharging operation of the water mists from above the burning surface can be overcome by using the two operations in combination as described in the third aspect of the present invention.

### BRIEF DESCRIPTION OF THE DRAWINGS

FIG. 1 shows a schematic drawing showing a fire-extinguishing method in accordance with Example 1.

FIGS. 2(a) and 2(b) are schematic drawings showing a fire-extinguishing method in accordance with Example 2, and FIG. 2(a) is a plan view, and FIG. 2(b) is an elevation thereof.

FIGS. 3(a) and 3(b) are schematic drawings showing a fire-extinguishing method of the present invention in accordance with Example 3, and FIG. 3(a) is a plan view, and FIG. 3(b) is an elevation thereof.

### BEST MODE FOR CARRYING OUT THE INVENTION

In the method of the present invention, by (i) an operation in which water mists are discharged so as to surround a flame base portion, with nozzles being directed not to the burning surface and the flame base portion directly, but to the flame center axis above this, from a plurality of positions on the side of the burning surface, or by (ii) an operation in which water mists are discharged toward the flame center axis above the flame base portion from a plurality of positions above the burning surface, or by using these operations in combination, a quick fire-extinguishing process is carried out with the use of a small amount of water.

In (i) the discharging operation of water mists from the sides of the burning surface, by surrounding the flame base portion virtually without a gap, the oxygen supply to the flame base portion is prevented, and the amount of oxygen supply required for burning is reduced to cause suffocation, thereby extinguishing the fire. In this method, when there is a problem in which, in a case of the presence of a freeboard, the water mists are hardly directed around the flame base portion with the result that flames tend to remain at the edge portion, this problem is prevented by executing (ii) the discharging operation of water mists from above the burning surface in combination.

With respect to the method for discharging water mists from the sides of the burning surface toward the flame center axis, for example, nozzles that generate water mists are installed at a plurality of positions with equal intervals around the burning face such as an oil vessel having the possibility of a pool fire so as to surround the burning surface, and water mists are discharged, with the nozzles being directed not to the burning surface and the flame base portion directly, but to any of positions of the flame center axis, so that a wall of water mists is formed in a cone shape.

With respect to discharging directions in a case of discharging water mists from the sides of the burning surface, it is preferable to set these directions virtually in parallel with the flow of flames as well as to the same direction as the flow thereof, so as to allow the water mists to block the flow of air that is directed toward the flame center portion from the flame base portion at the time of burning. Moreover, the discharging flow rate of the water mists is preferably set to a speed that can sufficiently prevent the air flow into the flame base portion, and actually, this is preferably set in a range from 0.1 m/s to 10 m/s, more preferably, from 0.3 m/s to 6 m/s.

In (ii) a case where water mists are discharged from above the burning surface, the water mists, discharged from a plurality of positions above the burning surface toward the flame center axis above the flame base portion, are made to collide with one another to descend in the flames, and then collide with the flames to be formed into vapor by the thermal energy of the flames; thus, the vapor is expanded to more than 1000 times the volume of the water mists. As a result, the inner pressure of the flames is increased, with the ambient oxygen concentration being reduced, while the flowing-in oxygen toward the flame base portion is restricted to extinguish the fire. Moreover, since the phase change from a liquid to a gas caused by the water mists takes place on the burning surface so that the flames are kept away from the burning surface and the igniting energy required for a chain reaction of burning is lost so that the fire is extinguished. In this method, in a case where there is a problem in which, upon arrival of the descending flow of the water mists onto the burning surface, a phenomenon of lateral expansion of flames occurs due to an increased pressure inside the flames, this problem is prevented by executing (i) the discharging operation of water mists from the sides of the burning surface in combination. In this case, since the lateral expansion of the flames is caused upon arrival of the descending flow of the water mists onto the burning surface, (i) the discharging of water mists from the sides of the burning surface is preferably carried out prior to the arrival of the descending flow.

With respect to the method for discharging water mists toward the flame center axis from above the burning surface, for example, nozzles capable of discharging water mists are installed at a plurality of positions on a circle around the flame center axis on the horizontal plane formed above the burning surface with equal intervals so that the corresponding operation is executed. In this case, the respective nozzles direct water mists toward any positions on the flame center axis below the horizontal plane; however, in order to prevent ambient air of flames from being flung up, preferably, the nozzles are not directed directly toward the burning surface and the flame base portion. The discharging flow rate of the water mists from above needs to be set to such a speed that the water mists are not flung up by flames, and also do not agitate the flames, and actually, it is preferably set in a range from 1 m/s to 3 m/s.

Moreover, the horizontal cross-sectional area of the descending flow of water mists is preferably made to be smaller than the burning area so as to allow the descending flow of water mists to extinguish the flames from below toward the edge of the flames; therefore, the area of the circle on the horizontal plane along which the respective nozzles are installed is preferably made smaller than the burning area on the oil surface.

The water mists may be generated by using any of conventionally known methods, and, for example, the discharging process may be carried out based upon the same principle as a fire extinguisher disclosed in Japanese Patent Publication Laid-Open No. 2004-135742. The average particle size of the water mists to be discharged is normally set in a range from 10 μm to 500 μm, and in a case of the discharging operation from the side positions, it is preferably set in a range from 10 μm to 200 μm, while in a case of the discharging operation from above, it is preferably set in a range from 50 μm to 500 μm. In a case of the discharging operation from the side positions, when the particle size is smaller than the above-mentioned lower limit, the water mists tend to be evaporated into vapor due to heat radiation from the flames prior to reaching the flames; in contrast, when the particle size is larger than the above-mentioned upper limit, the water mists are not completely evaporated even after passing through the flames to remain as water droplets; therefore, these cases are not preferable. Moreover, in a case of the discharging operation from above, when the particle size is smaller than the above-mentioned lower limit, the water mists are flung up by flames, failing to sufficiently absorb thermal energy of the flames; in contrast, when the particle size is larger than the above-mentioned upper limit, even after the passage through the flames, water droplets remain; therefore, these cases are not preferable.

### EXAMPLES

The following description will discuss the method of the present invention by means of examples; however, the present invention is not intended to be limited thereby.

### Example 1

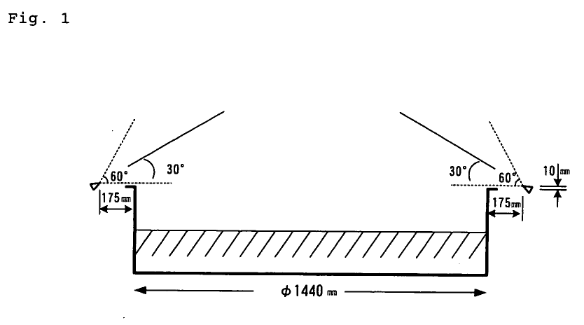

As shown in FIG. 1, a circular oil vessel having a diameter of 1440 mm and a depth of 300 mm was prepared, and 24 water mist generating nozzles were installed on the periphery thereof with equal intervals so that water mists having an average particle size of 100 μm could be discharged toward the upper portion in the center of the oil vessel with a discharging angle of 30° and a discharging range of 60°. Next, 48 liters of n-heptane was put into the oil vessel and this was set fire, and by surrounding the flame base portion without a gap by using the above-mentioned discharging method, the fire was extinguished; as a result, the fire-extinguishing time and the amount of use of water were respectively 17 seconds and 13.6 liters. Here, at the time of discharging the water mists, the water pressure was 0.9 MPa, the water flow rate was 48 liters/min, and the discharging flow rate of the water mists at a distance of 20 cm from the nozzle outlet was 5 m/s.

### Example 2

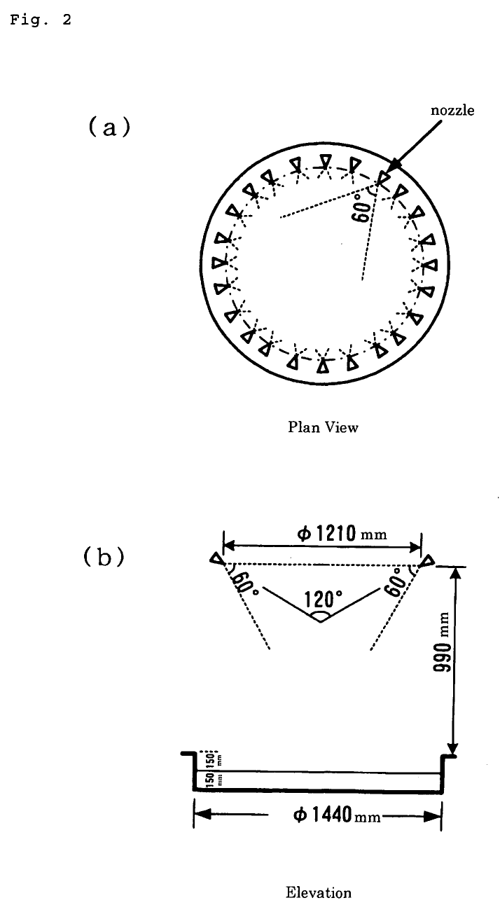

As shown in FIG. 2, a circular oil vessel having a diameter of 1440 mm and a depth of 300 mm was prepared, and 24 water mist generating nozzles were installed on a circle having a diameter of 1210 mm centered on a flame center axis (vertical center axis of the oil vessel) on a horizontal plane 990 mm above the edge of the oil vessel with equal intervals so that water mists having an average particle size of 100 μm could be discharged toward the flame center axis with a discharging angle of 30° from the horizontal plane and a discharging range of 60°. Next, n-heptane was put into the circular oil vessel up to a depth of 150 mm and this was set fire, and by discharging water mists not toward the burning surface and the flame base portion, but toward the flame center axis through the aforementioned discharging method, the fire was extinguished; as a result, the fire-extinguishing time was 21 seconds. Here, at the time of discharging the water mists, the water pressure was 0.9 MPa, the water flow rate was 48 liters/min, and the amount of use of water was 16.8 liters.

### Example 3

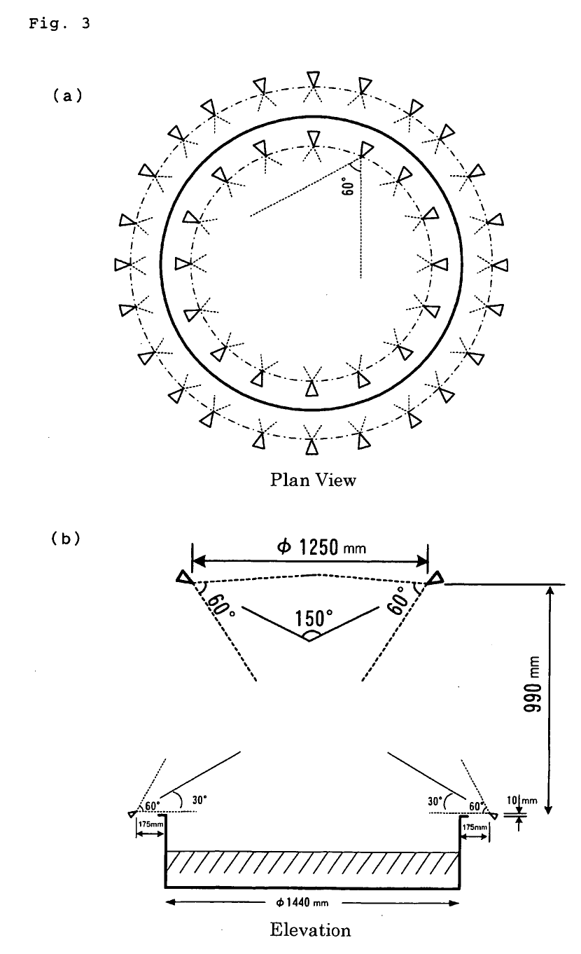

As shown in FIG. 3, a circular oil vessel having a diameter of 1440 mm and a depth of 300 mm was prepared, and 24 water mist generating nozzles were installed on the periphery of the oil vessel so that water mists having an average particle size of 100 μm could be discharged toward the upper portion in the center of the oil vessel with a discharging angle of 30° and a discharging range of 60°, while 16 water mist generating nozzles were installed on a circle having a diameter of 1250 mm centered on a flame center axis (vertical center axis of the oil vessel) on a horizontal plane 990 mm above the edge of the oil vessel with equal intervals so that water mists having an average particle size of 100 μm could be discharged toward the flame center axis with a discharging angle of 15° from the horizontal plane and a discharging range of 60°. Next, n-heptane was put into the circular oil vessel up to a depth of 150 mm and this was set fire, and the discharging operation from the edge of the oil vessel was started 4 seconds earlier than the discharging operation from above the oil vessel; thus, in accordance with this discharging method, in a case of the discharging operation from the periphery of the oil vessel, the flame base portion is surrounded without any gap, and in a case of the discharging operation from above the oil vessel, water mists were discharged not toward the burning surface and the flame base portion, but toward the flame center axis, so that the fire was extinguished; as a result, the fire extinguishing time was 13 seconds. Here, at the time of discharging the water mists, the water pressure was 0.9 MPa, and the water flow rate and the amount of use of water were respectively set to 32 liters/min and 6.4 liters in a case of the discharging operation from above the oil vessel, and were also respectively set to 9.6 liters/min and 2.1 liters in a case of the discharging operation from the edge of the oil vessel, and the discharging flow rate of water mists at a distance of 20 cm from the outlet of each of the nozzles placed on the periphery of the oil vessel was 3 m/s.

As clearly indicated by the results of the above-mentioned example 1 and example 2, by respectively carrying out the discharging operation from the edge of the oil vessel and the discharging operation from above the oil vessel, quick fire extinguishing operations are available. Moreover, as clearly indicated by the results of example 3, by carrying out the discharging operation from the edge of the oil vessel and the discharging operation from above the oil vessel in combination, a quicker fire extinguishing operation can be carried out with the use of a smaller amount of water.

In accordance with the method of the present invention, by utilizing side flows and/or a descending flow of water mists, the fire extinguishing operation of a pool fire can be positively carried out quickly with the use of a small amount of water, and therefore this method is effectively applied to a fire-extinguishing operation at a place having a possibility of a pool fire.

What is claimed is:

1. A fire-extinguishing method of a pool fire utilizing water mists, characterized in that the water mists are discharged toward the flame center axis above a flame base portion from a plurality of positions above the burning surface so as to generate a descending flow of water mists, and the descending flow forms vapor inside the flames so that the vapor increases the inner pressure of the flames to suppress a flow of oxygen toward the flame base portion, thereby extinguishing the fire.

2. The method according to claim 1, wherein nozzles capable of discharging water mists are placed at plurality of positions with equal intervals on a circle around the flame center axis on the horizontal plane above the burning surface, and the water mists are discharged with the nozzles being directed not to the burning surface and the flame base portion directly, but to any of positions of the same flame center axis below the horizontal surface.

3. A fire-extinguishing method of a pool fire utilizing water mists, characterized in that the water mists are discharged so as to surround the flame base portion of a pool fire virtually without a gap, with the nozzles being directed not to the burning surface and the flame base portion directly, but to any of positions of the flame center axis, so that an oxygen supply to the flame base portion is prevented by vapor generated from the water mists, thereby extinguishing the fire.

4. The method according to claim 3, wherein the discharging directions of the water mists are made virtually in parallel with flows of flames.

5. The method according to claim 3, wherein a flow rate of the water mists to be discharged is set to a speed that sufficiently preventing an air flow from entering the flame base portion.

6. The method according to claim 3, wherein the water mists to be discharged is set to an average particle size in a range from 10 μm to 200 μm.

7. A fire-extinguishing method of a pool fire utilizing water mists, characterized in that the water mists are discharged so as to surround the flame base portion of a pool fire virtually without a gap, directed not to the burning surface and the flame base portion directly, but to any of positions of the flame center axis from a plurality of positions on the side of the burning surface, while water mists are being discharged toward the flame center axis above the flame base portion from a plurality of positions above the burning surface, so that the fire is extinguished.

8. The method according to claim 7, wherein the discharging process of water mists from the sides of the burning surface is carried out prior to the discharging process of water mists from above the burning surface.

9. The method according to claim 7, wherein nozzles capable of discharging water mists are attached to a plurality of places with equal intervals so as to surround the burning surface on the periphery of the burning surface, and water mists are discharged with the nozzles being directed not to the burning surface and the flame base portion directly, but to any of positions of the flame center axis above the burning surface.

10. The method according to claim 7, wherein nozzles capable of discharging water mists are placed at a plurality of portions with equal intervals on a circle around the flame center axis on the horizontal plane above the burning surface, and the water mists are discharged with the nozzles being directed not to the burning surface and the flame base portion directly, but to any of positions of the flame center axis below the horizontal surface.
